(19) United States
(12) Patent Application Publication
(10) Pub. No.: US 2019/0179522 A1
(43) Pub. Date: Jun. 13, 2019

(54) Method, Mobile App and System for Adjusting Environment

(71) Applicants: Wen-Ta Chiu, Temple City, CA (US); Yu-Chuan Li, Temple City, CA (US); Wen-Shan Chien, Temple City, CA (US)

(72) Inventors: Wen-Ta Chiu, Temple City, CA (US); Yu-Chuan Li, Temple City, CA (US); Wen-Shan Chien, Temple City, CA (US)

(21) Appl. No.: 15/841,074

(22) Filed: Dec. 13, 2017

(51) Int. Cl. G06F 3/0484; G06F 3/0488; G06F 3/16; G06F 3/0482

(52) U.S. Cl. CPC G06F 3/04847; G06F 3/0488; H04W 88/02; G06F 3/0482; G06F 3/167

(57) ABSTRACT

The present application discloses a method for adjusting environment via a mobile app, comprising: selecting a control mode, wherein the control mode comprises a voice mode and a touch mode; selecting a control option, wherein the control option comprises a bed control option, a light control option, an equipment control option and a calling option; and adjusting a bed, a light or an equipment or calling for help, wherein the equipment comprises a curtain, a television, music or an air conditioner. The present application also discloses a mobile app comprising three control interfaces. The first control interface comprises a voice mode button and a touch mode button. The second control interface comprises a bed control button, a light control button, an equipment control button and a calling button. The third control interface enables a user to adjust a bed, lights, equipment or call for help.

### TECHNICAL FIELD OF THE INVENTION

The present application generally relates to mobile apps, and more particularly, to a method, a mobile app and a system for adjusting environment.

### BACKGROUND OF THE INVENTION

Generally, people need to move near the desired equipment for adjusting the environment such as turning off/on the light, adjusting the angle of the ward bed or controlling the temperature. However, for people in the hospital or clinic, it is not an efficient way since patients may need assistance and medical personnel may be busy due to other patients.

In addition, patients with more serious illness may even have difficulties to turn their body over or sit, not to say stand up and walk. Therefore, a need remains for a method, a mobile app and a system for adjusting environment.

### SUMMARY OF THE INVENTION

The present application discloses a method, a mobile app and a system for adjusting environment.

A method for adjusting environment via a mobile app, comprising: selecting a control mode, wherein the control mode comprises a voice mode and a touch mode; selecting a control option, wherein the control option comprises a bed control option, a light control option, an equipment control option and a calling option; and adjusting a bed, a light or an equipment or calling for help, wherein the equipment comprises a curtain, a television, music or an air conditioner.

In various exemplary embodiments, the bed control option comprises a head option and a feet option, the step of adjusting the bed, the light or the equipment or calling for help comprises selecting the head option or the feet option.

In various exemplary embodiments, the light control option comprises a bedside lamp option, a room light option, a bathroom light option and an all lights option, the step of adjusting the bed, the light or the equipment or calling for help comprises selecting the bedside lamp option, the room light option, the bathroom light option or the all lights option.

In various exemplary embodiments, the equipment control option comprises a curtain option, a television option, a music option and an air conditioner option, the step of adjusting the bed, the light or the equipment or calling for help comprises selecting the curtain option, the television option, the music option or the air conditioner option.

In various exemplary embodiments, the calling option comprises a moving option, a bathroom option and a schedule option, the step of adjusting the bed, the light or the equipment or calling for help comprises selecting the moving option, the bathroom option or the schedule option.

The present application also discloses a mobile app for adjusting environment, comprising a first control interface, a second control interface and a third control interface. The first control interface comprises a voice mode button and a touch mode button. The second control interface comprises a bed control button, a light control button, an equipment control button and a calling button. The third control interface enables a user to adjust a bed, lights, equipment or call for help, wherein the equipment comprises a curtain, a television, music or an air conditioner.

According to an exemplary embodiment of the mobile app for adjusting environment, wherein the third control interface comprises a head portion button and a feet portion button. An angle of a head portion is changed 10° when pressing the head portion button once. An angle of a feet portion is changed 10° when pressing the feet portion button once.

According to the other exemplary embodiment, wherein the third control interface comprises a bedside lamp button, a room light button, a bathroom light button and an all lights button.

According to the other exemplary embodiment, wherein the third control interface comprises a bedside lamp button, a room light button, a bathroom light button and an all lights button.

According to the other exemplary embodiment, wherein the third control interface comprises a curtain button, a television button, a music button and an air conditioner button.

According to the other exemplary embodiment, wherein the third control interface comprises a moving button, a bathroom button and a schedule button.

The present application also discloses a system for adjusting environment via a mobile app, comprising a mobile device and an adjusting interface installed in the mobile device. The adjusting interface comprises a first control interface, a second control interface and a third control interface. The first control interface comprises a voice mode button and a touch mode button. The second control interface comprises a bed control button, a light control button, an equipment control button and a calling button. The third control interface enables a user to adjust a bed, lights, equipment or call for help, wherein the equipment comprises a curtain, a television, music or an air conditioner.

According to an exemplary embodiment of the system for adjusting environment via the mobile app, wherein the third control interface comprises a head portion button and a feet portion button.

According to the other exemplary embodiment, wherein the third control interface comprises a bedside lamp button, a room light button, a bathroom light button and an all lights button.

According to the other exemplary embodiment, wherein the third control interface comprises a bedside lamp button, a room light button, a bathroom light button and an all lights button.

According to the other exemplary embodiment, wherein the third control interface comprises a curtain button, a television button, a music button and an air conditioner button.

According to the other exemplary embodiment, wherein the third control interface comprises a moving button, a bathroom button and a schedule button.

Based on the above, the present application allows either patients or medical personnel to have more efficient way for adjusting environment such as controlling the angle of the ward bed, temperature, music or other furniture by voice control or touch the screen of the mobile device. In addition, patients with more serious illness also can call for help simply by speaking to the mobile app.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates flow charts of a method for adjusting environment.

FIG. 2 illustrates a first control interface of a mobile app for adjusting environment.

FIG. 3 illustrates a second control interface of the mobile app for adjusting environment.

FIGS. 4-7 illustrate a third control interface of the mobile app for adjusting environment.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

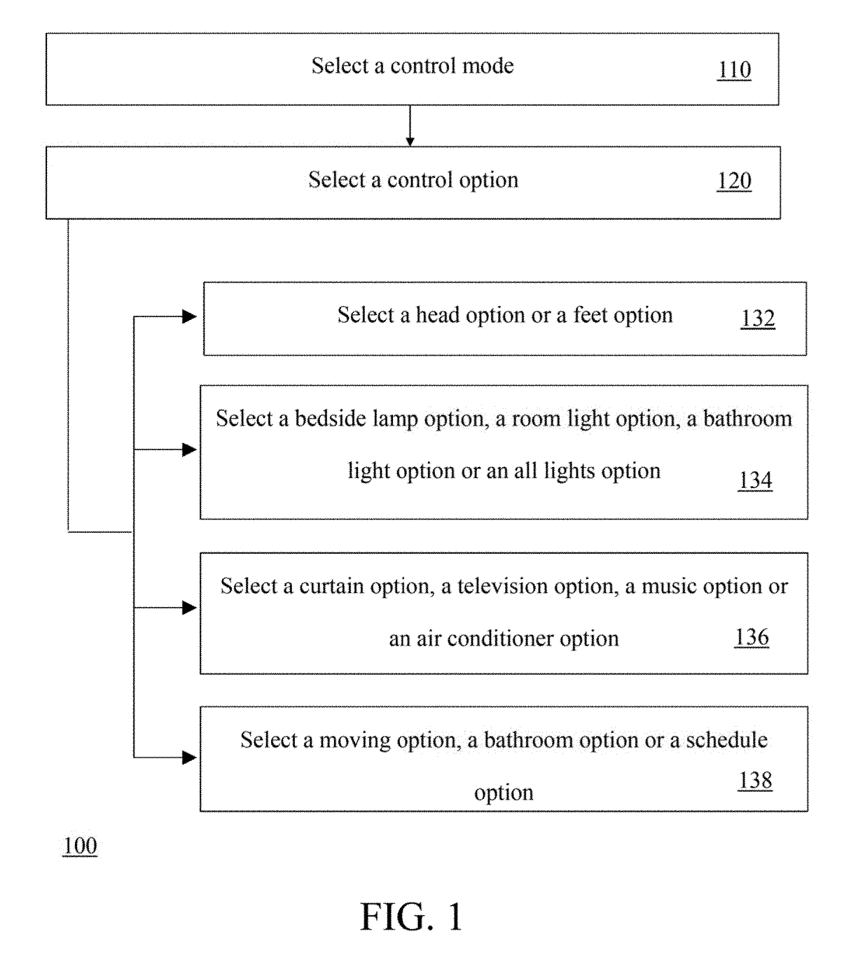

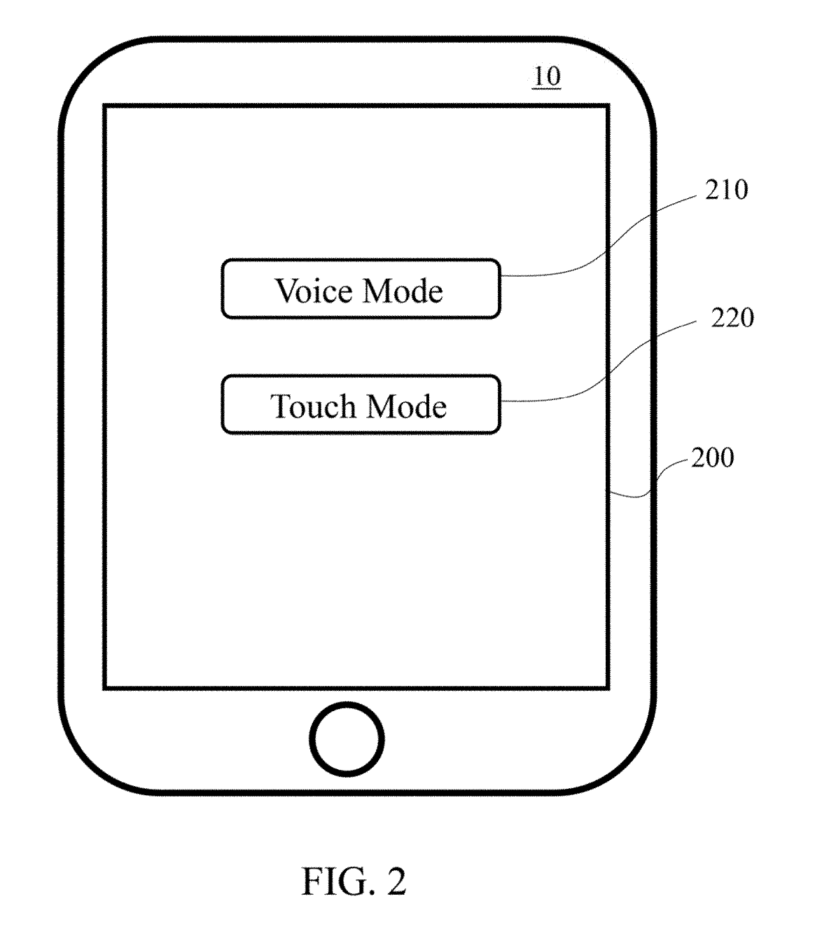

FIG. 1 illustrates flow charts of a method 100 for adjusting environment. FIG. 2 illustrates a first control interface of a mobile app for adjusting environment.

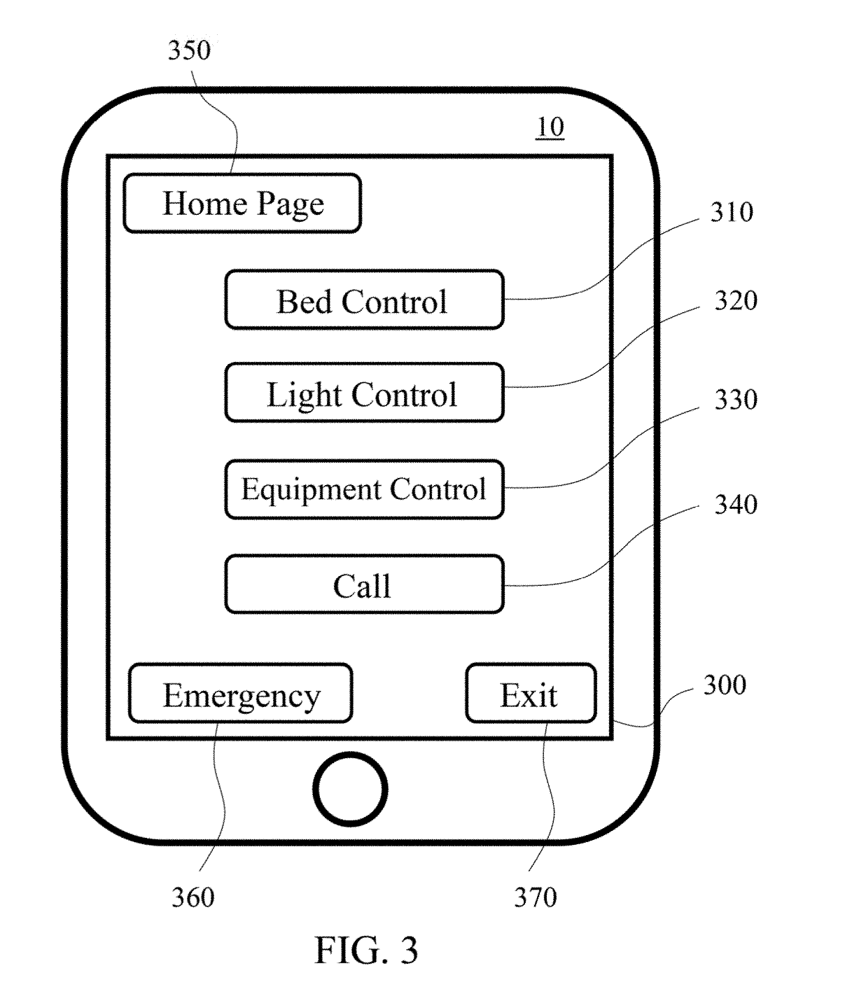

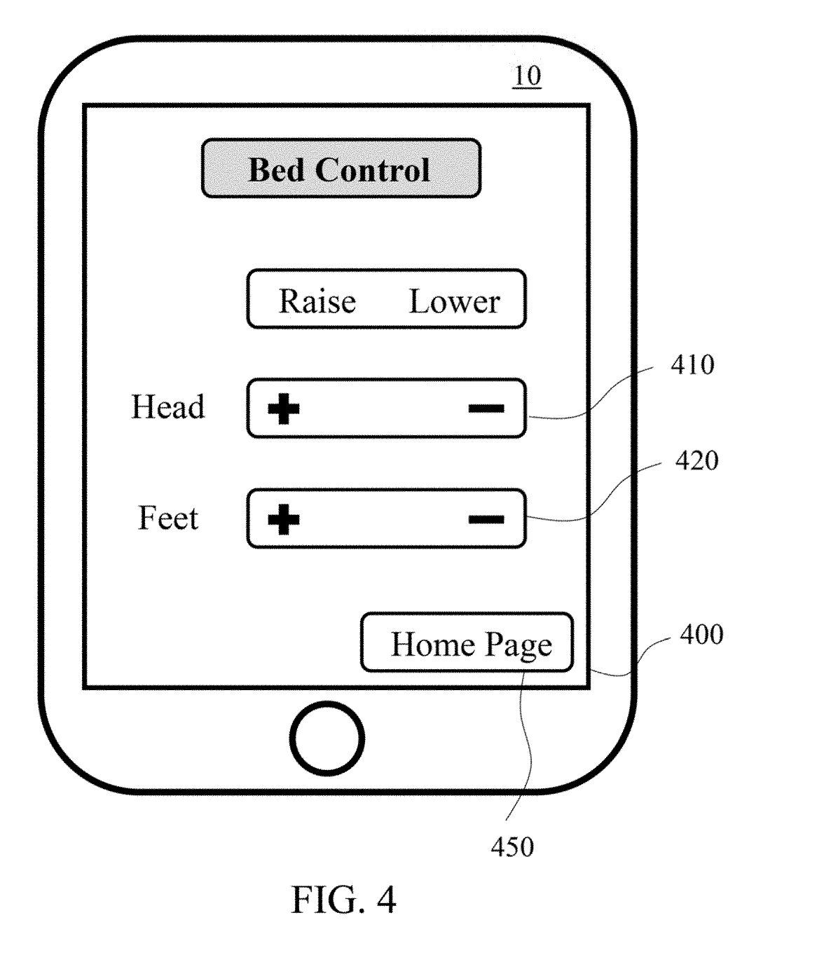

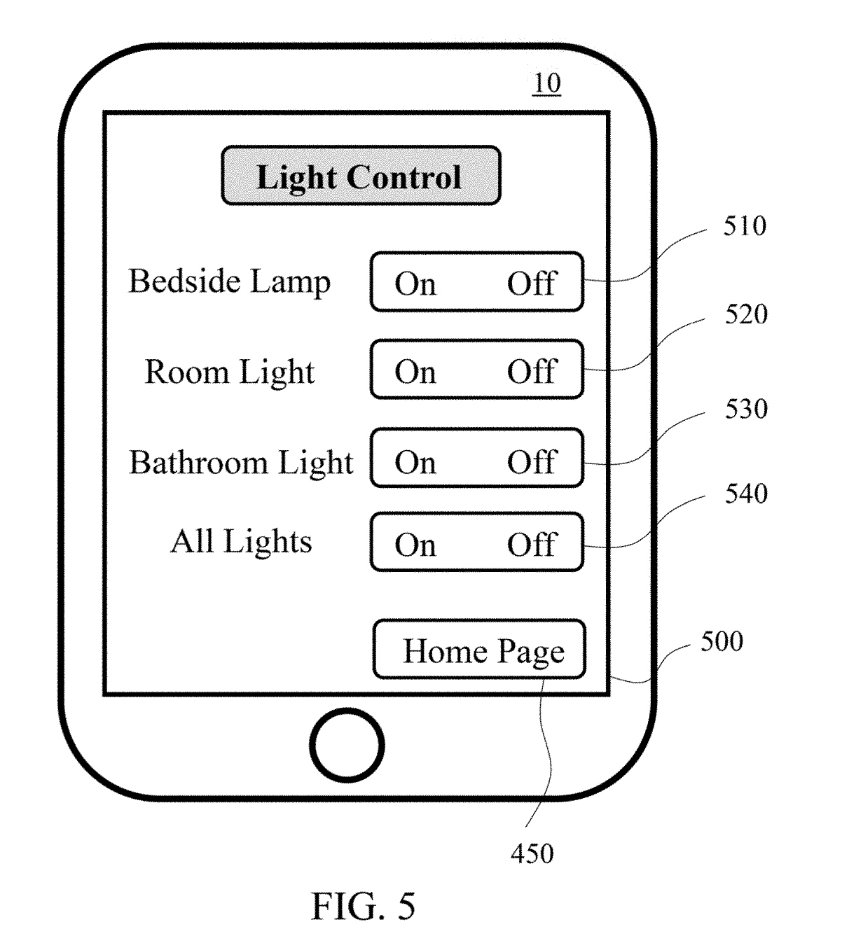

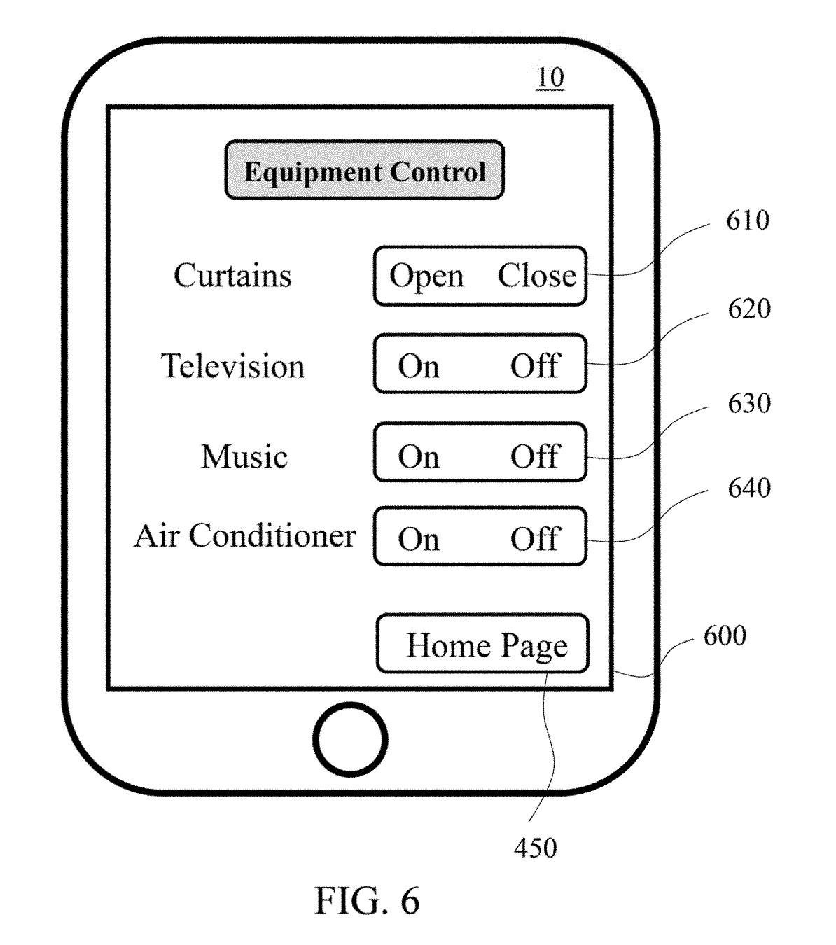

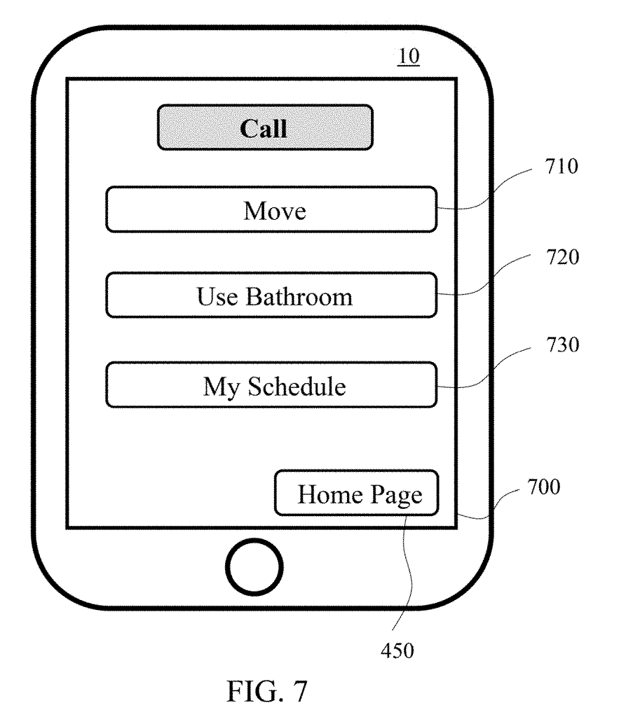

Referring to FIGS. 1-2, the present application discloses a system and a method 100 for adjusting environment via a mobile app. This system and method 100 are mainly for the patients or their family members in a care center such as hospital or clinic. The system comprises a mobile device 10 and a mobile app installed therein. The mobile app comprises a first control interface 200, a second control interface 300 (referring to FIG. 3) and a third control interface 400/500/600/700 (referring to FIGS. 4-7). As shown in step 110 and FIG. 2, the first step is selecting a control mode in the first control interface 200.

The control mode comprises a voice mode and a touch mode as shown in a voice mode button 210 and a touch mode button 220. The user can select the desired mode for controlling. In addition, the voice mode comprises English mode, Spanish mode, Mandarin mode and Cantonese mode. Therefore, the user may simply control the mobile app via speaking. The touch mode also comprises English, Spanish, Mandarin and Cantonese interface. The user may select the desired language for the following steps. However, the present application is not limited thereto, the voice mode and the touch mode may also comprise other language mode. The following description will utilize the touch mode with English version as an example.

FIG. 3 illustrates a second control interface 300 of the mobile app for adjusting environment.

Referring to FIG. 1 and FIG. 3, as shown in step 120, the second control interface 300 is shown after selecting the control mode. The second control interface 300 comprises a bed control button 310, a light control button 320, an equipment control button 330, a calling button 340, a home page 350, an emergency button 360 and an exit button 370.

The interface will jump to the first control interface 200 (referring to FIG. 2) when pressing the home page button 350. The emergency medical technicians at the care center will receive a notice when the user pressing the emergency button 360. The current system will be ended when pressing the exit button 370.

FIGS. 4-7 illustrate a third control interface 400/500/600/700 of the mobile app for adjusting environment.

The user then may select a desired button for adjusting a bed, a light or an equipment or calling for help. Referring to FIG. 1 and FIGS. 3-4, the third control interface 400 may jump out when pressing the bed control button 310. The third control interface 400 comprises a head portion button 410, a feet portion button 420 and a home page button 450. The first control interface 200 (referring to FIG. 2) will appear when pressing the home page button 450. As shown in step 132, the user can select a head option or a feet option for adjusting the angle of the ward bed. Specifically, an angle of a head portion of the ward bed is changed 10° when pressing the head portion button 410 once, and an angle of a feet portion is changed 10° when pressing the feet portion button 420 once. Therefore, the user can control the desired portion of the ward bed for raising up or lowering down. The purpose for setting as 10° is because this angle is more moderate for a patient when changing the bending angle of the ward bed.

Referring to FIG. 1 and FIG. 3 and FIG. 5, the third control interface 500 may jump out when pressing the light control button 320. The third control interface 500 comprises a bedside lamp button 510, a room light button 520, a bathroom light button 530, an all lights button 540 and the home page button 450. As shown in step 134, the user can select a bedside lamp option, a room light option, a bathroom light option or an all lights option for turning off or turning on the desired light. However, the present application is not limited thereto, the bedside lamp, room light or the bath room light also can be adjusted to different brightness. For example, the bedside lamp, the room light, the bathroom light or all lights may be adjusted to darky brightness. It should be noted that the lamp or light is not limited as bedside lamp, room light or bathroom light, the light may also be aisle light or entrance light.

Referring to FIG. 1 and FIG. 3 and FIG. 6, the third control interface 600 may jump out when pressing the equipment control button 330. The third control interface 600 comprises a curtain button 610, a television button 620, a music button 630, an air conditioner button 640 and the home page button 450. As shown in step 136, the user can select a curtain option, a television option, a music option or an air conditioner option for opening or closing the curtains or turning on or turning off the equipment such as the television, music or the air conditioner. However, the present application is not limited thereto, the equipment may also be other furniture such as microwave or heater.

Referring to FIG. 1 and FIG. 3 and FIG. 7, the third control interface 700 may jump out when pressing the calling button 340. The third control interface 700 comprises a moving button 710, a bathroom button 720, a schedule button 730 and the home page button 450. As shown in step 138, the user can select a moving option, a bathroom option or a schedule option. Specifically, if the patient needs help for moving such as getting off the ward bed or eating, the patient, his/her family member or friend may press the moving button 710 to let the medical personnel or other care workers be noticed. In addition, if the patients need more people's help such as for using bathroom, he/she may press bathroom button 720 to call for help. Furthermore, the schedule button 730 is used to view the personal examination schedule. Specifically, if the user need to know the examination schedule, he/she may press the schedule button 730 for requesting the details.

Based on the above, the present application allows either patients or medical personnel to have more efficient way for adjusting environment such as controlling the angle of the ward bed, temperature, music or other furniture by voice control or touch the screen of the mobile device. In addition, patients with more serious illness also can call for help simply by speaking to the mobile app.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A method for adjusting environment via a mobile app, comprising:
selecting a control mode, wherein the control mode comprises a voice mode and a touch mode;
selecting a control option, wherein the control option comprises a bed control option, a light control option, an equipment control option and a calling option; and
adjusting a bed, a light or an equipment or calling for help, wherein the equipment comprises a curtain, a television, music or an air conditioner.

2. The method for adjusting environment via the mobile app as claimed in claim 1, wherein the bed control option comprises a head option and a feet option, the step of adjusting the bed, the light or the equipment or calling for help comprises selecting the head option or the feet option.

3. The method for adjusting environment via the mobile app as claimed in claim 1, wherein the light control option comprises a bedside lamp option, a room light option, a bathroom light option and an all lights option, the step of adjusting the bed, the light or the equipment or calling for help comprises selecting the bedside lamp option, the room light option, the bathroom light option or the all lights option.

4. The method for adjusting environment via the mobile app as claimed in claim 1, wherein the equipment control option comprises a curtain option, a television option, a music option and an air conditioner option, the step of adjusting the bed, the light or the equipment or calling for help comprises selecting the curtain option, the television option, the music option or the air conditioner option.

5. The method for adjusting environment via the mobile app as claimed in claim 1, wherein the calling option comprises a moving option, a bathroom option and a schedule option, the step of adjusting the bed, the light or the equipment or calling for help comprises selecting the moving option, the bathroom option or the schedule option.

6. A mobile app for adjusting environment, comprising:
a first control interface comprising a voice mode button and a touch mode button;
a second control interface comprising a bed control button, a light control button, an equipment control button and a calling button; and
a third control interface enabling a user to adjust a bed, lights, equipment or call for help, wherein the equipment comprises a curtain, a television, music or an air conditioner.

7. The mobile app for adjusting environment as claimed in claim 6, wherein the third control interface comprises a head portion button and a feet portion button.

8. The mobile app for adjusting environment as claimed in claim 7, wherein an angle of a head portion is changed 10° when pressing the head portion button once.

9. The mobile app for adjusting environment as claimed in claim 7, wherein an angle of a feet portion is changed 10° when pressing the feet portion button once.

10. The mobile app for adjusting environment as claimed in claim 6, wherein the third control interface comprises a bedside lamp button, a room light button, a bathroom light button and an all lights button.

11. The mobile app for adjusting environment as claimed in claim 6, wherein the third control interface comprises a bedside lamp button, a room light button, a bathroom light button and an all lights button.

12. The mobile app for adjusting environment as claimed in claim 6, wherein the third control interface comprises a curtain button, a television button, a music button and an air conditioner button.

13. The mobile app for adjusting environment as claimed in claim 6, wherein the third control interface comprises a moving button, a bathroom button and a schedule button.

14. A system for adjusting environment via a mobile app, comprising:
a mobile device; and
an adjusting interface installed in the mobile device, comprising:
a first control interface comprising a voice mode button and a touch mode button;
a second control interface comprising a bed control button, a light control button, an equipment control button and a calling button; and
a third control interface enabling a user to adjust a bed, lights, equipment or call for help, wherein the equipment comprises a curtain, a television, music or an air conditioner.

15. The system for adjusting environment via the mobile app as claimed in claim 14, wherein the third control interface comprises a head portion button and a feet portion button.

16. The system for adjusting environment via the mobile app as claimed in claim 14, wherein the third control interface comprises a bedside lamp button, a room light button, a bathroom light button and an all lights button.

17. The system for adjusting environment via the mobile app as claimed in claim 14, wherein the third control interface comprises a bedside lamp button, a room light button, a bathroom light button and an all lights button.

18. The system for adjusting environment via the mobile app as claimed in claim 14, wherein the third control interface comprises a curtain button, a television button, a music button and an air conditioner button.

19. The system for adjusting environment via the mobile app as claimed in claim 14, wherein the third control interface comprises a moving button, a bathroom button and a schedule button.
